(19) United States
(12) Patent Application Publication
(10) Pub. No.: US 2010/0104004 A1
(43) Pub. Date: Apr. 29, 2010

(54) VIDEO ENCODING FOR MOBILE DEVICES

(76) Inventors: Smita WADHWA, Bangalore (IN); Srinath TV, Tumkur (IN); Pawan GUPTA, Bangalore (IN)

Correspondence Address: HICKMAN PALERMO TRUONG & BECKER LLP/Yahoo! Inc., 2055 Gateway Place, Suite 550, San Jose, CA, 95110-1083, US

(21) Appl. No.: 12/258,238

(22) Filed: Oct. 24, 2008

(51) Int. Cl. H04N 7/12

(52) U.S. Cl. 375/240.01; 375/E07.076

(57) ABSTRACT

Techniques are described to encode video content for mobile devices. A video content that is to be transmitted to a mobile device is received and different scenes are determined for the video content. For each scene that is found in the video content, one or more analysis techniques are performed on the scene. Based upon the results of the analysis techniques, the portion of the image to retain on each scene is determined. Finally, the video content containing the portion of the image on each scene to be retained is encoded based upon the type of the mobile device that will display the video content. The location and dimensions of each portion to be retained may vary from scene to scene, as these characteristics are determined on a per-scene basis.

### FIELD OF THE INVENTION

The present invention relates to video content on mobile devices.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Video content is often created for viewing on large display screens, such as movie theaters or television. Each of these display devices has a particular aspect ratio, or the ratio of the display's width divided by the display's height. Common aspect ratios used in the presentation of films in movie theaters are 1.85:1 and 2.39:1. Common aspect ratios for televisions are 4:3 (1.33:1) for standard-definition video formats and 16:9 (1.78:1) for high-definition television and European digital television formats.

An example of different aspect ratios is shown in FIG. 1. In FIG. 1, element 101 is an example of a standard television format aspect ratio of 4:3 or 1.33:1. Element 103 illustrates an example of a high-definition widescreen format with an aspect ratio of 16:9 or 1.85:1. The significance of the different aspect ratios is visible when an image is viewed within the display area. In element 103, a magician and a castle may be seen in the widescreen format. For the standard television aspect ratio in element 101, however, only the magician is visible in the image and the castle is cropped out when the same image is displayed.

If a video content originally created for viewing in movie theaters (aspect ratio 1.85:1) is to be shown on a television screen (aspect ratio 4:3), then the video content is reformatted to the appropriate aspect ratio in order to display correctly on the television screen. Reformatting content from one aspect ratio to another aspect ratio may be performed using various manual techniques, such as pan and scan or tilt and scan. In tilt and scan, the image is cropped vertically so that a standard television aspect ratio may be viewed on a movie widescreen. In pan and scan, the sides of the original widescreen image are cropped so that the widescreen image appears correctly on a standard television aspect ratio.

An example of pan and scan may be viewed in element 105 of FIG. 1. In element 105, the part of the image to the right of a dotted line 107 represents the part of the image that is cropped to convert from a widescreen aspect ratio to a standard television ratio. In the diagram, the castle that may be seen in the widescreen aspect ratio is no longer visible once the image is cropped to the standard television aspect ratio. Cropping via pan and scan is performed by a creative team through a manual process of an editor selecting what part of the image should be cropped. In pan and scan, the dimensions of the cropped area is fixed for the entire video content, as one aspect ratio is converted to another aspect ratio.

Technology has progressed such that users are able to view content on non-traditional devices. For example, mobile devices are now able to display video content to users due to improved display technology and faster broadband capabilities. Examples of mobile devices may include, but are not limited to, smartphones, cellular phones, personal digital assistants (PDAs), portable multimedia players, and any other portable device capable of displaying video content. If the quality of the user experience is high, then viewing content on mobile devices may become another medium that content providers are able to exploit.

However, problems arise when converting video content for display on mobile devices. First, there is no standard screen aspect ratio for mobile devices. For example, a mobile device from Apple Computer may have a slightly different display dimension than a mobile device from Samsung. The conversion of video content for mobile screens is often performed prior to transmission of the video content to the client, meaning only a single conversion is made of the video content to a smaller aspect ratio. This single conversion is then transmitted to any user who wishes to view the content, regardless of the mobile device used. The single conversion may lead to problems where one user is viewing on a mobile device from Apple with one dimension, and another user is viewing on a mobile device form Samsung with another dimension. The video content may appear distorted or difficult to view. Second, the small dimensions of the screens on mobile devices may cause viewing details in video content difficult. For example, a video content may be directly re-sized so that none of the picture is cropped. Under this circumstance, scaled images that result from a direct re-sizing conversion may leave the video appearing extremely small, leading to a poor user experience. Third, there are many different types and variations of file formats that are compatible with particular mobile devices, making encoding of the video content a non-trivial task. Examples of these file formats are MPEG-4, H.264, and Windows Media for video, and AMR, AAC, MP3, and WMA for audio.

Ideally, the most essential parts of a given video content are identified and retained in the converted video content. However, conversion of video content to a small screen is not an easy task, whether the process is performed automatically or manually. An automatic task, such as cropping out the peripheral part of video, might make the video content meaningless by removing important parts of the video. In manual editing, the cost is much higher because manual editing requires expensive creative teams and the time required is so great. Thus methods that provide inexpensive, fast conversions with high accuracy are highly desirable.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a diagram displaying different aspect ratios and an example of pan and scan to adjust content from one aspect ratio to another aspect ratio;

FIGS. 2A and 2B are diagrams displaying types of encoding video content from the content provider to end users, according to an embodiment of the invention;

FIG. 3 is a diagram displaying the steps of a technique for encoding video content for mobile devices, according to an embodiment of the invention; and

FIG. 4 is a block diagram of a computer system on which embodiments of the invention may be implemented.

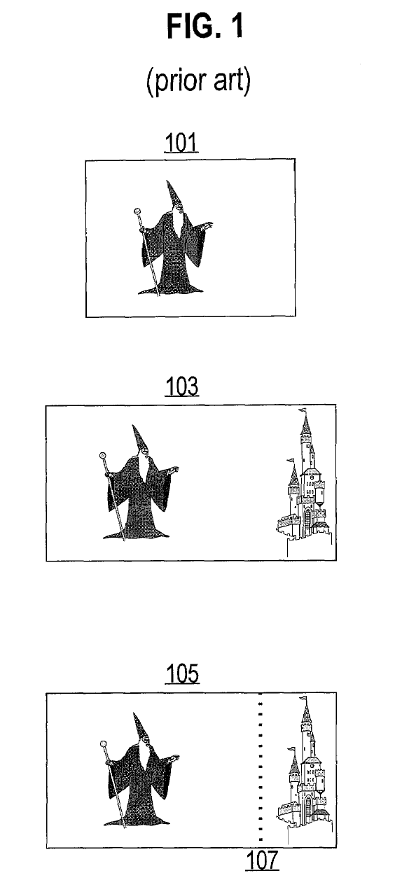

### DETAILED DESCRIPTION

Techniques are described to encode video content for mobile devices. In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

An automated process that converts video content to be compatible with mobile devices is described herein. A video content is received that is to be transmitted to a mobile device and different scenes are determined for the video content. For each scene that is found in the video content, one or more analysis techniques are performed on the scene. In an embodiment, the analysis may be performed only on select candidate frames of the scene. Based upon the results of the analysis techniques, the portion of the image to retain on each scene is determined. Finally, the video content containing the portion of the image on each scene to be retained is encoded based upon the type of the mobile device that will display the video content. The location and dimensions of each portion to be retained may vary from scene to scene, as these characteristics are determined on a per-scene basis.

### Determining Scenes in a Video Content

Video content is received from a content provider to be encoded for mobile devices. The video content may be received from the content provider over a network or through receiving a broadcast of the video content. For example, video content may be a movie or television series that might be sent directly by the content provider for mobile device encoding. The video content may be sent in digital format over a network or may also come in the form of removable storage media (e.g. DVD). Video content might also be a live broadcast such as a sporting event. Under this circumstance, the video content is broadcast either digitally or by analog by the content provider. The video content is received during the broadcast and may be encoded to be transmitted to mobile devices in a real-time manner.

Once the video content is received, the video content is divided into a series of logical scenes. In an embodiment, any analysis technique is used to determine a break point from one scene to another scene. For example, one technique might be to scan the video content to find a sequence where a fade-out occurs. In a fade out, the content shows an image that gradually darkens and disappears. A fade-out often delineates where one scene might end and another scene begins. In another example, background objects of a scene are analyzed. At the point in a video content where background objects change, the change may indicate that one scene ends and another scene begins. Any other type of analysis technique that is capable of determining a border of one scene to another scene may be used to determine the set of scenes in the video content. In another embodiment, scenes are not determined. This might occur where real-time transmission of a video content broadcast is performed. For the transmission to occur in real-time or close to real-time, the delay caused by waiting for each scene to be determined is not feasible.

The borders of each scene are break points that determine how many scenes are in the video content. Video content may vary widely and have hundreds of different scenes, while other video content may have only a single scene. Each scene is then placed through analysis techniques to determine which part of an image to retain for the scene.

### Applying Analysis Techniques to Each of the Scenes

One or more analysis techniques are performed on each scene of the video content to determine the part of the image to retain for the particular scene. In an embodiment, each image of the scene is analyzed by each of the one or more analysis techniques. In another embodiment, a specified number of frames are selected from the scene to perform the analysis techniques.

In an embodiment, candidate frames are selected to be analyzed for each scene. The number of candidate frames selected for each scene may vary from implementation to implementation. In an embodiment, a minimum specified number of frames are selected per scene. For example, an administrator might specify that at least ten frames are required for each scene to be evaluated. In another embodiment, a specified minimum ratio is used to determine the number of candidate frames selected for each scene. For example, an administrator might specify that a ratio of 1/20 is required per scene. Under this circumstance, the ratio of 1/20 would indicate that at least one frame out of every twenty must be selected as a candidate frame. Thus, if a scene had a total of 1000 frames, then at least fifty frames are selected as candidate frames. Using candidate frames greatly decreases the amount of processing that is required to evaluate a video content because analysis is not performed on every single frame of a scene.

Candidate frame selection may also vary depending upon the implementation. In one embodiment, candidate frames are selected based upon a central frame of a scene. As used herein, central frames are those frames that are a specified distance or time from the borders for each scene. For example, if a scene was twenty seconds long, then central frames might be defined as those frames that exist between the eighth and twelfth second of the scene. Central frames may be defined by an administrator and may be changed based upon the video content. Central frames overcome the effects of gradual transitions in scenes and avoid false analysis results that may occur with a fade-in and a fade-out

In another embodiment, candidate frames may be selected from frames that are close to the scene borders. This is in direct contrast to selecting central frames. Border frames may be selected because frames close to borders do not need extra processing to determine whether a frame is a central frame or a border frame.

In another embodiment, all of the frames of a particular scene are used to analyze the scene. Though analyzing every frame might be processor intensive, the accuracy provided may, in some cases, outweigh using only candidate frames to determine the portion of an image to retain. For example, a chase scene might be fast moving and present numerous changes in camera angle. Under this circumstance, analyzing a specified ratio of frames might not be enough information to determine the correct part of the image to retain. Rather, more processing time should be taken and every frame analyzed to ensure that the part of the image to retain is correct.

In an embodiment, the core action area of video content is identified and non-important parts of the video are cropped. To ensure proper conversion to a small screen size, a series of analyses are performed on the video content and then a cropping window is calculated to crop the video to the smaller screen. One or more analysis techniques are used to determine the important areas of the image and which part of the image to retain. The analysis techniques used will vary from implementation to implementation. In addition, some analysis techniques may work well with particular conditions in a video content (a fast-paced action film) and not in other conditions (a slow-paced drama). Thus, a different combination of analysis techniques may be used depending upon the genre of the video content or the type of video content (live sports broadcast vs. movie).

The analysis techniques described herein are not the exclusive techniques that may be used, but represent only a sample of the many different types of analysis techniques that may be implemented. In an embodiment, as few as one analysis technique may be used to determine the part of the image to retain. In other embodiments, more than one analysis technique is used. The combination of the analysis techniques used may also vary depending upon the implementation. The analysis techniques may be developed exclusively to determine important areas of an image or may be products from third parties or open source providers. For example, algorithms might be obtained from the open source provider, Open Computer Vision Library, and incorporated with other algorithms to create the set of analysis techniques. Black border detection is an analysis technique that detects vertical or horizontal black borders in an image and stores the pixel coordinates of the borders. Black horizontal or vertical borders may often be removed to focus on the important portion of the image. For example, in an opening credits scene, the title of the movie might appear on the center of the image with black border areas on either side of the title. The black border areas may be safely cropped because no important content is located in that part of the image.

In face detection, frontal faces are detected in an image and rectangular pixel coordinates of the face are stored. Faces are often the most important part of an image and thus, this particular area of the image is often retained. Problems may occur, however, in scenes where many faces are present such as crowd scenes.

Edge detection detects edges in an image and stores the pixels of the location of the edge. Edges may indicate a border area on the image. If more objects are located on one side of the edge than the other side of the edge, then the edge containing more objects is often more important and should be retained.

Object detection analysis detects objects in an image. In object detection, the objects are marked and rectangular pixel coordinates of the objects are stored. The object detection algorithm may also indicate whether the object is significant or not. For example, if the object is moved from one frame to another frame, then the object might be more significant than objects that do not move. The criteria for determining whether an object is significant vary based upon the implementation. Based upon the number of objects and the significance of the object, particular parts of the image may be selected for retention.

Camera central focus analysis detects the center of the camera focus in an image and records the coordinates of the central camera focus. In this technique, the location in an image where the camera is focused often provides an indication of the most important portion of the image and the area of the image in which to retain. For example, a large crowd scene may display a large number of individuals. The camera may focus only on the two main characters on the right side of the image with other members of the crowd not in focus. Camera central focus would determine that the right side of the image with the two main characters would be the area of the image to retain.

Any or all of the above described techniques may be used to determine the portion of an image to retain for a scene. Additionally, any other type of analysis techniques may also be employed to provide additional information to determine the important portion of an image.

In an embodiment, results from each of the analysis techniques are weighted to determine the portion of the image to retain. For example, the analysis techniques camera central focus, face detection, and black border detection might be the three analysis techniques used to determine the part of an image to retain for a scene. Initially, each of the three analysis techniques might be given an equal weighting of 0.33. After considerable use, a determination might be made that camera central focus provides a more accurate reading of what portion of an image to retain than face detection. Thus, under such circumstances, camera central focus would be given a higher weighting than face detection. The modified weightings might be camera central focus (0.40), face detection (0.26), and black border detection (0.34).

In an embodiment, the weightings are dependent upon the genre of the video content. For example, video content of drama might have different weightings of analysis techniques than video content of action adventure. Video content of action adventure might have scenes with more movement and so particular analysis techniques might need to have a higher weighting in order to determine a portion of the image to retain more accurately. In another embodiment, the weightings are dependent upon the subject matter of the video content. For example, a video content of a sporting events might have weightings that favor object detection and central camera focus while a video content for sitcoms might have weightings that favor face detection.

For each scene of the video content, the portion of the image to retain is independently calculated. The portion of the image selected may vary in dimensions for different scenes. For example, the dimension of the portion of the image in a first scene might be different than the dimension of the portion of the image for other scenes in the video content. The first scene might be a large shot with a lot of scenery with characters in a small area of the right part of the image. Thus, the analysis techniques determine that the portion of the image to retain in the first scene is the small area where the characters are located. In the second scene, a dialog may occur between two characters in the middle of the image. In order to retain both characters, the portion of the image to retain in the second scene is large enough to retain both characters and is a much larger dimension than the dimension to retain in the first scene. The varying dimensions and size of the portion of the image to retain is important because these results might be used for conversions to different aspect ratios. For example, conversion of the aspect ratio from 1.85:1 to 1.33:1 using pan and scan might be based on a fixed cropping size. Under this circumstance, the fixed cropping size would not be useful for any other types of conversions. A conversion to a different aspect ratio using the pan and scan data would lead to a scaled picture that might be distorted. However, if the dimension and size of the portion to retain varied but always included the significant area of the image, then the results may be used for conversions to any aspect ratio as long as the encoded scene included the portion of the image to be retained.

In an embodiment, the portion of the image selected is not stationary for the scene. For example, if a character is located in a scene and moves across the screen from the left side to the right side, then the portion of the image selected would also move across the screen to follow the character. This also follows the premise that the significant area of any image is always contained in the area of the image to be retained.

### Encoding the Video Content for Mobile Devices

Once the portion of the image to be retained is selected for each scene, then the video content may be encoded for transmission to a mobile device. As used herein, encoding refers to the process of transforming the video content from one format into another format. For example, content providers might supply content in MPEG-2, which provides broadcast-quality content. The format might need to be converted to a more compressed data format, such as Windows Media, for display on a mobile device.

The final encoding step of the conversion creates a new video, scaling down images for each scene while including the portion of the image to be retained. In an embodiment, the scaling is also optimized for each individual screen form factor and preferred file format of a mobile device. The final result is a video content where each scene is scaled and encoded optimally for a particular mobile screen.

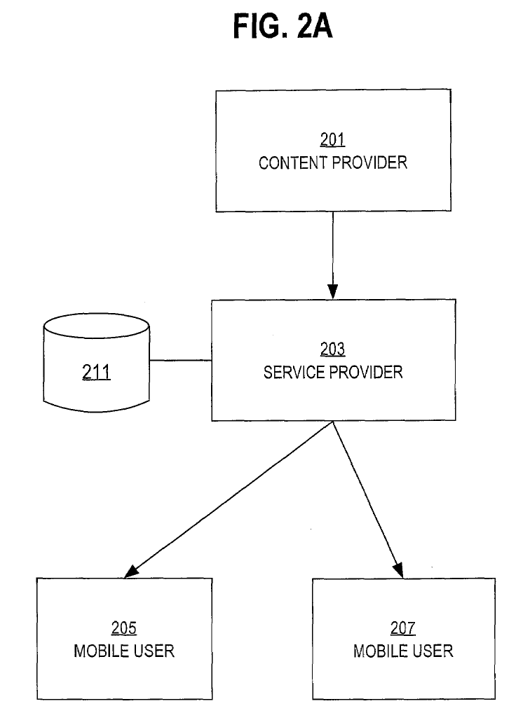

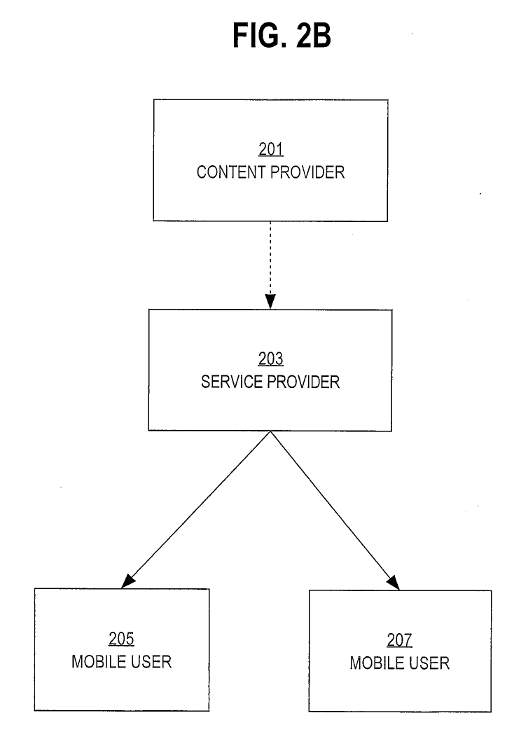

The encoding and transmission of the video content from the service provider to end users may be performed in a variety of ways. In one embodiment, the video content is encoded for a mobile device and retained in storage by the service provider for later transmission to the user. Under this scenario, video content is prepared prior to any requests from users. The content may be encoded in any type of file format and may be scaled to fit particular dimensions of various mobile devices. Though this may require extensive storage, transmission to mobile users is immediate if the file format and scaling is available. An example of this type of encoding is shown under FIG. 2A. In FIG. 2A, content provider 201 provides service provider 203 with the video content. The service provider 203 encodes the video content in various sizes and file formats and stores the encoded video content is storage 211. Upon request from users, service provider 203 transmits the video content to mobile user 205 and mobile user 207.

In another embodiment, the video content is encoded for the mobile device and transmitted to the user upon encoding (real-time). For example, a service provider might receive a broadcast of a sporting event from a content provider. The service provider wishes to provide a transmission of this broadcast in real-time. Analysis techniques may be provided to the broadcast on the fly without a determination of different scenes of the video content in order to determine the portion of images to retain. The video content is then encoded based upon the types of mobile devices expected and the transmission to the end users is made. This method does not require storage by the service provider. An example of this type of encoding is shown in FIG. 2B. In FIG. 2B, content provider 201 broadcasts video content to service provider 203 (broadcast is shown by the dotted line). The service provider 203 encodes the video content immediately for transmission to mobile users. Based upon the types of mobile devices used, service provider may optimally encode video content for transmission to mobile user 205 and mobile user 207.

### Illustrated Steps

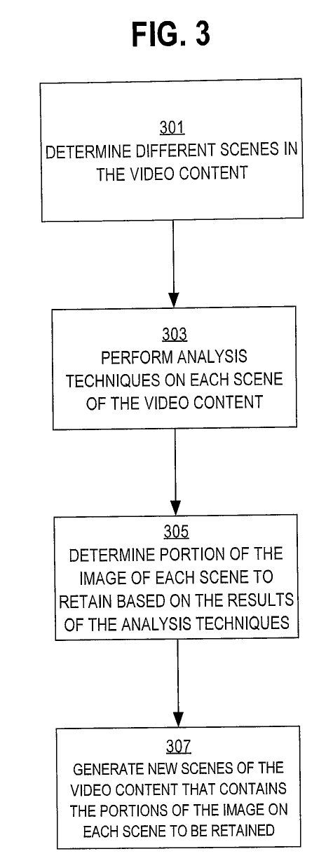

FIG. 3 is a diagram displaying each of the steps of a technique for encoding video content for mobile devices. In step 301, each of the different scenes are determined for the received video content. This step might not occur in real-time transmission where determining different scenes may unduly delay video content encoding. As shown in step 303, one or more analysis techniques are performed on each scene of the video content. The number of analysis techniques may vary from implementation to implementation and may even vary based upon the subject matter of the video content. In step 305, the results of each of the analysis techniques are used to determine which portion of the image to retain. The analysis techniques may be given different weightings to make a final determination and the weightings may change based upon the genre or the subject matter of the video content. The size and dimension of the portion of the image to retain may vary from scene to scene. This is important as conversions to various aspect ratios and dimensions may continue to use the same findings of the analysis techniques. Finally, in step 307, new scenes, each of which includes the portions of the image to be retained for that scene are encoded. The encoding scales the video content optimally for the screen size of a particular mobile device and also provides the video content in a preferred file format.

### Hardware Overview

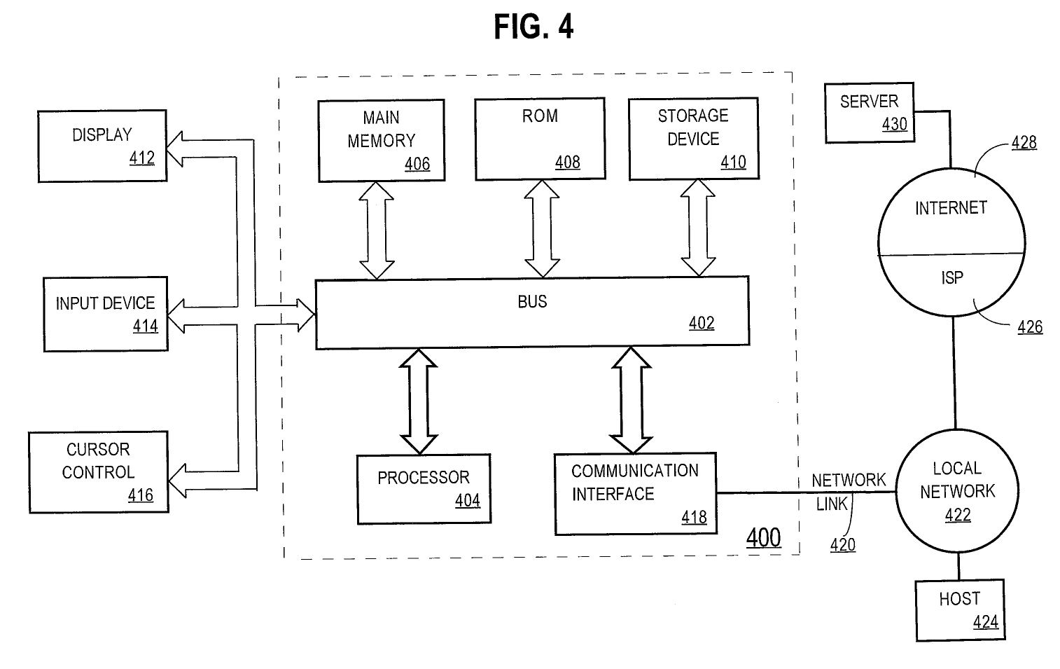

FIG. 4 is a block diagram that illustrates a computer system 400 upon which an embodiment of the invention may be implemented. Computer system 400 includes a bus 402 or other communication mechanism for communicating information, and a processor 404 coupled with bus 402 for processing information. Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Computer system 400 further includes a read only memory (ROM) 408 or other static storage device coupled to bus 402 for storing static information and instructions for processor 404. A storage device 410, such as a magnetic disk or optical disk, is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

The invention is related to the use of computer system 400 for implementing the techniques described herein. According to one embodiment of the invention, those techniques are performed by computer system 400 in response to processor 404 executing one or more sequences of one or more instructions contained in main memory 406. Such instructions may be read into main memory 406 from another machine-readable medium, such as storage device 410. Execution of the sequences of instructions contained in main memory 406 causes processor 404 to perform the process steps described herein. In alternative embodiments, hard-wired circuitry may be used in place of or in combination with software instructions to implement the invention. Thus, embodiments of the invention are not limited to any specific combination of hardware circuitry and software.

The term “machine-readable medium” as used herein refers to any medium that participates in providing data that causes a machine to operation in a specific fashion. In an embodiment implemented using computer system 400, various machine-readable media are involved, for example, in providing instructions to processor 404 for execution. Such a medium may take many forms, including but not limited to storage media and transmission media. Storage media includes both non-volatile media and volatile media. Non-volatile media includes, for example, optical or magnetic disks, such as storage device 410. Volatile media includes dynamic memory, such as main memory 406. Transmission media includes coaxial cables, copper wire and fiber optics, including the wires that comprise bus 402. Transmission media can also take the form of acoustic or light waves, such as those generated during radio-wave and infra-red data communications. All such media must be tangible to enable the instructions carried by the media to be detected by a physical mechanism that reads the instructions into a machine.

Common forms of machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 404 for execution. For example, the instructions may initially be carried on a magnetic disk of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are exemplary forms of carrier waves transporting the information.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution. In this manner, computer system 400 may obtain application code in the form of a carrier wave.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A computer-implemented method to encode a video content, comprising:
performing one or more analysis techniques on scenes of a video content;
for each scene, determining a portion of an image of a particular dimension based upon results of the one or more analysis techniques, wherein the particular dimension of the portion of the image of one scene is different than the particular dimension of the portion of the image of other scenes; and
generating new scenes based upon the portion of the image determined for each scene.

2. The method of claim 1, wherein the one or more analysis techniques include at least one of: black border detection, face detection, object detection, edge detection, and camera central focus.

3. The method of claim 1, wherein each of the one or more analysis techniques is given a specified weighting to determine the portion of the image.

4. The method of claim 3, wherein the specified weightings are determined based upon genre of the video content.

5. A computer-readable storage medium carrying one or more sequences of instructions which, when executed by one or more processors, causes the one or more processors to:
perform one or more analysis techniques on scenes of a video content;
for each scene, determine a portion of an image of a particular dimension based upon results of the one or more analysis techniques, wherein the particular dimension of the portion of the image of one scene is different than the particular dimension of the portion of the image of other scenes; and
generate new scenes based upon the portion of the image determined for each scene.

6. The computer-readable storage medium of claim 5, wherein the one or more analysis techniques include at least one of: black border detection, face detection, object detection, edge detection, and camera central focus.

7. The computer-readable storage medium of claim 5, wherein each of the one or more analysis techniques is given a specified weighting to determine the portion of the image.

8. The computer-readable storage medium of claim 7, wherein the specified weightings are determined based upon genre of the video content.

9. A computer-implemented method to encode a video content, comprising:
determining, in a video content, shot boundaries that mark borders between scenes in the video content;
based upon the shot boundaries, generating a set of scenes for the video content;
for each scene in the set of scenes, performing one or more analysis techniques;
determining, based upon results of the one or more analysis techniques, a subset of an image of the video content for each scene;
encoding the video content that contains the subset of the image of the video content for each scene to a particular dimension.

10. The method of claim 9, wherein generating a set of scenes further comprises selecting a particular number of candidate frames for each scene with the one or more analysis techniques performed on each candidate frame for each scene.

11. The method of claim 10, wherein the particular number of candidate frames is determined based upon a minimum number of frames.

12. The method of claim 10, wherein the particular number of candidate frames is determined based upon a minimum ratio.

13. The method of claim 9, wherein the subset of the image of the video content for each scene to retain is not fixed to a particular dimension.

14. The method of claim 9, wherein the one or more analysis techniques include at least one of: black border detection, face detection, object detection, edge detection, and camera central focus.

15. The method of claim 9, wherein each of the one or more analysis techniques is given a specified weighting to determine the subset of the picture.

16. The method of claim 15, wherein the specified weightings are determined based upon genre of the video content.

17. A computer-readable storage medium carrying one or more sequences of instructions which, when executed by one or more processors, causes the one or more processors to:
determine, in a video content, shot boundaries that mark borders between scenes in the video content;
based upon the shot boundaries, generate a set of scenes for the video content;
for each scene in the set of scenes, perform one or more analysis techniques;
determine, based upon results of the one or more analysis techniques, a subset of an image of the video content for each scene;
encode the video content that contains the subset of the image of the video content for each scene to a particular dimension.

18. The computer-readable storage medium of claim 17, wherein generating a set of scenes further comprises selecting a particular number of candidate frames for each scene with the one or more analysis techniques performed on each candidate frame for each scene.

19. The computer-readable storage medium of claim 18, wherein the particular number of candidate frames is determined based upon a minimum number of frames.

20. The computer-readable storage medium of claim 18, wherein the particular number of candidate frames is determined based upon a minimum ratio.

21. The computer-readable storage medium of claim 17, wherein the subset of the image of the video content for each scene to retain is not fixed to a particular dimension.

22. The computer-readable storage medium of claim 17, wherein the one or more analysis techniques include at least one of: black border detection, face detection, object detection, edge detection, and camera central focus.

23. The computer-readable storage medium of claim 17, wherein each of the one or more analysis techniques is given a specified weighting to determine the subset of the picture.

24. The computer-readable storage medium of claim 23, wherein the specified weightings are determined based upon genre of the video content.
